(19) United States
(12) Patent Application Publication
(10) Pub. No.: US 2009/0212005 A1
(43) Pub. Date: Aug. 27, 2009

(54) EMBOSSING CYLINDER AND METHOD FOR MODIFYING THE EMBOSSING PATTERN OF AN EMBOSSING CYLINDER

(75) Inventor: Giovanni GAMBINI, Pisa (IT)

Correspondence Address: LUCAS & MERCANTI, LLP, 475 PARK AVENUE SOUTH, 15TH FLOOR, NEW YORK, NY, 10016, US

(73) Assignee: GAMBINI INTERNATIONAL S.A., Luxembourg (LU)

(21) Appl. No.: 12/391,628

(22) Filed: Feb. 24, 2009

(30) Foreign Application Priority Data
Feb. 26, 2008 (IT) MI2008A000309

(51) Int. Cl. B44C 1/22; B29C 59/04

(52) U.S. Cl. 216/9; 425/385

(57) ABSTRACT

An embossing cylinder (10) comprising a central cylindrical body (11) and supports for bearings (12, 12′) projecting laterally from the circular ends of the central cylindrical body (11), wherein the central cylindrical body (11) comprises an internal cylindrical portion (13) and a coating (14), the coating (14) being provided molten on the internal cylindrical portion (13) and being made of softer material than the material that forms the internal cylindrical portion (13), easy to engrave and with high resistance against abrasion.

### CROSS-REFERENCE TO RELATED APPLICATIONS

This application claims the benefit of priority from Italian Paten Application No. MI2008A000309, filed Feb. 26, 2008, the contents of which are incorporated herein by reference.

### FIELD OF THE INVENTION

The present invention refers to an improved embossing cylinder and a method for modifying the embossing pattern of an embossing cylinder.

### BACKGROUND OF THE INVENTION

Currently known common embossing cylinders, generally made of steel, have—on the external surface—a plurality of small projections suitably spaced from each other which, during the step of using these rollers, perform surface engravings on the material, usually paper, which is in contact with the embossing cylinder itself.

Thus, these cylinders are used to perform—on the surface—for example of the paper, an embossed pattern which can have aesthetic or functional purposes.

As a matter of fact use of such embossed paper element is quite common today in the household environment, in particular as toilet paper or a paper towels, but also in other similar fields of application.

However, disadvantageously, once processed during production, the external surface of the embossing roll according to a determined embossed pattern according to the geometry of the pattern intended to be made on the paper, it is no longer possible to change such pattern at will without replacing the entire embossing cylinder.

Today, such drawback weighs negatively on the economical aspect due to the changing market demands that imply substantial costs for replacing embossing cylinders and the required regeneration of the bearings where the new cylinder is mounted.

### SUMMARY OF THE INVENTION

An object of the present invention is that of providing a device capable of overcoming the abovementioned drawbacks of the known art in an extremely simple, inexpensive and particularly functional manner.

Another object is that of providing an improved embossing cylinder, and a method for modifying the embossed pattern of an embossing cylinder, which allows modifying the related embossed pattern without requiring the replacement of the entire cylinder.

Still another object is that of having an improved embossing cylinder, and a method for modifying the embossed pattern of an embossing cylinder, which allows modifying the related embossed pattern at a low cost and within very short periods of time.

These objects according to the present invention are attained by providing an improved embossing cylinder, and a method for modifying the embossed pattern in an embossing cylinder, as respectively outlined in the claims.

Further characteristics of the invention are outlined by the dependent claims.

### BRIEF DESCRIPTION OF THE DRAWING

Characteristics and advantages of an improved embossing cylinder and of the method for modifying the embossed pattern of an embossing cylinder according to the present invention shall be clearer from the following exemplifying and non-limiting description, referring to the attached schematic drawings wherein:

FIG. 1 is an improved embossing cylinder according to the present invention.

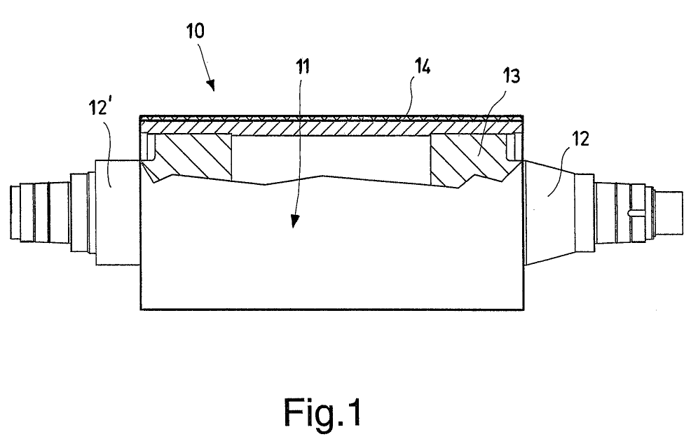

### DETAILED DESCRIPTION

Referring to the FIGURE, is shown an embossing cylinder 10 which comprises a central cylindrical body 11 and supports 12, 12′ for the embossing cylinder 10 itself, generally couplable to bearings, which project laterally from the circular ends of the central cylindrical body 11.

In particular, such central cylindrical body 11 comprises and internal cylindrical portion 13, generally made of steel, and a coating 14.

According to the invention such coating 14 is provided molten on the internal cylindrical portion 13.

Furthermore, according to the invention, the abovementioned coating 14 is made material that is easy to engrave, with high resistance against abrasion and it must be softer than the material that forms the internal cylindrical portion 13.

For exemplifying and non limiting purposes, the coating 14 may be made of common plastic both of the thermosetting and thermoplastic type.

According to the description outlined above, the coating 14 may be easily engraved according to any embossed pattern obtaining a relative improved embossing cylinder 10.

In particular the abovementioned improved embossing cylinder 10 may in such manner have an embossed pattern possibly different from an embossed pattern previously obtained on the external surface of the internal cylindrical portion 13 covered by the coating 14 and no longer accessible from the external.

According to the description outlined above, the method according to the present invention for modifying the embossed pattern present on a common embossing cylinder is clear.

Such method comprises the following steps:

a) providing—in the molten state—the coating 14 on the common embossing cylinder, wherein, as previously described, such coating 14 must be made of softer material than the material that forms the embossing cylinder, must be easy to engrave, and must further have high resistance to abrasion;
b) engraving the coating 14 according to any embossed pattern depending on the needs.

According to a preferred embodiment, the step of engraving the coating 14 according to any embossed pattern depending on the needs, may be advantageously performed by means of laser engraving providing high accuracy for such technique.

It has thus been observed that the improved embossing cylinder 10 according to the present invention attains the objects described above.

As a matter of fact, the improved embossing cylinder, and the method for modifying the embossed pattern of a common embosser according to the present invention, allows providing an embossing cylinder wherein the embossed pattern may be modified at will.

Furthermore, advantageously such change of the embossed pattern present on the original embossing cylinder occurs at a low cost and Within very short periods of time.

Lastly, it is observed how the improved embossing cylinder 10 according to the present invention advantageously provides a very rigid structure, as required by the art, and it does not require regenerating the housings of the bearings where the supports of the regenerated cylinder are accommodated.

The improved embossing cylinder of the present invention as conceived is susceptible to numerous modifications and variants, all falling within the same inventive concept; furthermore, all details can be replaced with other technically equivalent elements. In practice, the materials used, as well as dimensions thereof, may vary depending on the technical requirements.

We claim:

1. Embossing cylinder comprising a central cylindrical body and supports projecting laterally from the circular ends of said central cylindrical body, characterised in that said central cylindrical body comprises an internal cylindrical portion and a coating, said coating being provided molten on said internal cylindrical portion and being made of softer material than the material that forms said internal cylindrical portion, easy to engrave and with high resistance against abrasion.

2. Embossing cylinder according to claim 1 wherein said coating is made of plastic.

3. Method for modifying the embossed pattern of an embossing cylinder comprising the following steps:
a) providing—in molten state—a coating on said embossing cylinder, said coating being made of softer material than the material that forms said embossing cylinder, easy to engrave and with high resistance against abrasion.
b) engraving said coating according to any embossed pattern.

4. Method according to claim 3 characterised in that said step of engraving said coating according to any embossed pattern occurs by means of an engraving laser.
